(19) United States
(12) Patent Application Publication
(10) Pub. No.: US 2023/0230466 A1
(43) Pub. Date: Jul. 20, 2023

(54) Assisted Response MAtrix

(71) Applicants: Gene Edward Anderson, Spring, TX (US); Michael Gene Edward Anderson, Spring, TX (US)

(72) Inventors: Gene Edward Anderson, Spring, TX (US); Michael Gene Edward Anderson, Spring, TX (US)

(21) Appl. No.: 17/576,028

(22) Filed: Jan. 14, 2022

(51) Int. Cl. G08B 21/02; G08B 21/18

(52) U.S. Cl. CPC G08B 21/02; G08B 21/182

(57) ABSTRACT

The present disclosure provides a system comprising a plurality of multisensory wearable personal safety and tracking “assisted response” devices that are capable of local and remote communications over a network and with a number of tracking tags affixed to or integrated with objects of value. Each assisted response device is in constant communication with the network and configured to broadcast alarms and/or distress signals in response to various triggers that indicate a user's safety or the safety of their possessions has been compromised. The system can also be used in larger emergencies to co-ordinate response efforts.

### CROSS REFERENCES TO RELATED APPLICATIONS

The present application claims the benefit and priority of US provisional application no. U.S. 63/132,457, filed 30 Dec. 2020.

### FIELD OF INVENTION

The present invention relates to a system comprising a plurality of networked personal safety and tracking devices with multiple sensors and tracking modules for both individuals and assets and items.

### BACKGROUND

An inherent problem with the distribution, sale, and purchase of valuable items is the risk of theft or loss of the items, since the items have no inherent method of tracking built into them.

Products and methods have been proposed and developed in an attempt to facilitate tracking and theft prevention. These technologies often include complex optical scanning systems, magnetic coding, microwave systems having transmitters and receivers, infrared systems, line-of-sight type systems, mechanical systems requiring physical contact with the object.

Some object locating and tracking systems have been developed around technologies that use tags placed on the objects to be tracked and a scanner or reader to recognize the tags and to read information stored on the tags. These tags can either be active transmitting devices or passive devices. Examples of applications for these technologies include product inventory, grocery store checkouts, and package tracking. Each reader is generally a stand-alone, independent system capable of monitoring and obtaining information only on the objects that pass within its range. Generally, this range is very small, on the order of a few feet or less. In addition, the tags used in these systems are relatively expensive, making them suitable for expensive items but less suitable for inexpensive consumer items such as those purchased in a grocery store or discount store.

Given the limitations and relatively high costs of these tracking and locating systems, an improved method for tracking and locating objects that is less expensive is desired. Suitable methods would permit a consumer to easily tag desired objects, to identify the importance of those objects, and to assign any necessary information related to those objects. In addition, it is desired to be able to track those objects across greater volumes of space and not to confine the locating and tracking of those items to fixed areas where scanners are located.

Furthermore, no systems or devices have previously been proposed which both carry out the above-mentioned tagging and tracking of objects to prevent theft and loss, while simultaneously incorporating personal safety and security measures such as distress signal capabilities with integrated GPS broadcasting for assisting quick responses to a user's location.

It is within this context that the present invention is provided.

### SUMMARY

The present disclosure provides a system comprising a plurality of multisensory wearable personal safety and tracking “assisted response” devices that are capable of local and remote communications over a network and with a number of tracking tags affixed to or integrated with objects of value. Each assisted response device is in constant communication with the network and configured to broadcast alarms and/or distress signals in response to various triggers that indicate a user's safety or the safety of their possessions has been compromised. The system can also be used in larger emergencies to co-ordinate response efforts.

Thus, according to one aspect of the present disclosure there is provided a personal safety and tracking system, the system comprising one or more assisted response devices in communication over a network, each assisted response device comprising: two or more separate power sources; one or more cameras; a wireless communications module; a GPS tracking module; one or more proximity sensors; a device interface and display configured to receive a distress input, alarm input, one or more trigger instructions, and one or more mode of operation instructions.

Each assisted response device further comprises a controlling processor, the processor configured to output a distress signal to other assisted response devices within a predetermined radius or geographical location of the device and to one or more third parties, and to begin a recording with the one or more cameras, when a distress input is received; the processor being further configured to output an alarm signal in response to predetermined trigger instructions entered by a user or based on a selected mode of operation.

In some embodiments, the assisted response devices are in the form of a wearable device configured with one or more straps to be fastened about the forearm of a user.

In some embodiments, one of the power sources of each assisted response device is configured to receive a DC input, and is also provided with a DC/AC converter.

In some embodiments, the device interface comprises a touchscreen interface.

In some embodiments, the device interface comprises a manual distress button.

In some embodiments, the device interface comprises a microphone coupled to a voice activation software of the controlling processor.

In some embodiments, the separate power sources comprise a set of replaceable batteries and a set of internal rechargeable batteries.

In some embodiments, the system further comprises a plurality of anti-theft transceiver tags coupled to the assisted response devices, the transceiver tags configured to be attached to one or more objects owned by a user and to communicate with the proximity sensors of the assisted response devices to alert a user when the object is moved a predetermined distance away from the assisted response unit.

In such embodiments, the modes of operation may include a network mode, and when in the network mode the device is configured to communicate over the network to check for other assisted response devices within a predetermined geographical area or radius.

Furthermore, in such embodiments, the modes of operation may include a proximity mode, and when in the proximity mode the device is configured to emit an alarm when a transceiver tag is moved further than a set limit away from the device.

Furthermore, in such embodiments, the modes of operation may include an alarm mode, and when in the alarm mode the device is configured to instruct a specific transceiver to set an alarm for a pre-determined amount of time, the alarm being triggered if the transceiver is moved without de-activating the alarm.

Furthermore, in such embodiments, the system may further comprises transceiver tags or tracking and alarm software specifically for vehicles, and wherein the vehicle tags or software are configured to generate an alert on the network when the vehicle is taken without the alarm being disabled, the alert containing information about the vehicle entered by a user, such as the number plate and a vehicle description, as well as continuously broadcasting the location of the vehicle.

In some embodiments, each assisted response unit further comprises a satellite communications module, and wherein the modes of operation include a travel mode, and when in the travel mode the device is configured to communicate with the network, send alerts, and broadcast a user's location via the satellite communications module.

In some embodiments, the assisted response device comprises an integrated heart rate sensor, and is configured to determine that a user is in distress under certain heartrate increase thresholds, and in response to broadcast a distress signal over the network.

In some embodiments, the assisted response device comprises a first camera for taking photographs and a second camera for taking video recordings, and wherein the controlling processor is configured to broadcast photographs and video recordings taken over the network in combination with alarm or distress signals.

In some embodiments, the assisted response device comprises voice recognition and recording software coupled to the microphone, and is configured to broadcast voice recordings taken over the network in combination with alarm or distress signals.

In some embodiments, the system is in communication with an emergency response system installed in one or more buildings, the emergency response system in each building comprising a set of cameras, tracking sensors, and visual indicators, which in combination provide situational data on the whereabouts and status of building occupants during an emergency by broadcasting the video and tracking data over the network, and with the visual indicators being configured to guide responders to distressed building occupants and guide building occupants out of the building.

Furthermore, in some embodiments, the assisted response devices involved in responding to building emergencies have the guide and visual data overlaid on the display of their device.

### BRIEF DESCRIPTION OF THE DRAWINGS

Various embodiments of the invention are disclosed in the following detailed description and accompanying drawings.

FIG. 1 illustrates a functional diagram of an example network architecture over which the system of the present disclosure may be implemented.

FIG. 2 illustrates a functional block diagram of the internal components of an example configuration of an assisted response device for use in accordance with the system of the present disclosure.

FIG. 3 illustrates an isometric perspective view of an example configuration of an assisted response device in accordance with the present disclosure.

FIG. 4 illustrates a side perspective view of the example configuration of the assisted response device in accordance with the present disclosure.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

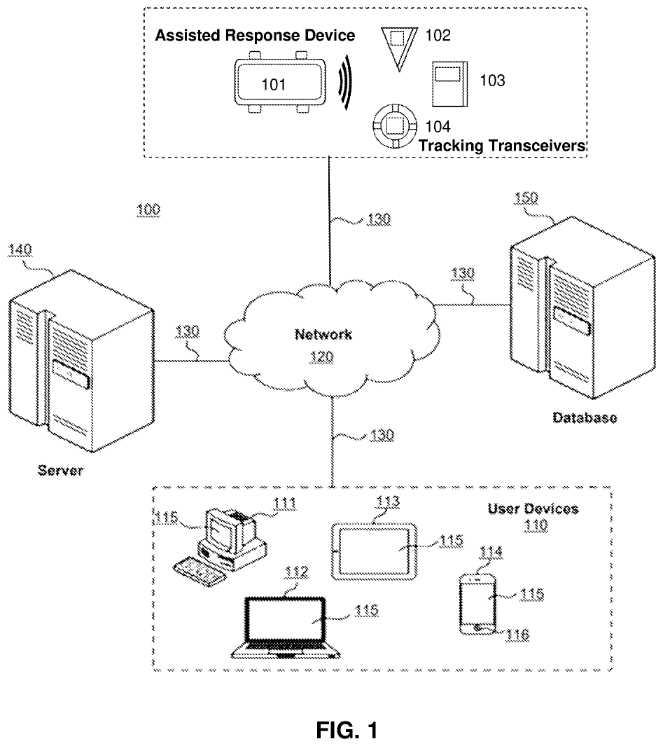

Referring now to FIG. 1, an exemplary embodiment of a network over which a Personal safety and security system 100 may be implemented is shown.

In this example, the personal safety and security system 100 permits a user making use of an assisted response device 101 to securely and continuously track a number of assets to which one or more transceivers 102, 103, 104 are attached, as well as monitoring the personal well-being of a user and broadcasting alerts and alarms to other assisted response devices in various situations.

Each assisted response device 101 has two or more separate power sources (usually replaceable and rechargeable batteries) to increase reliability and prevent tampering. The device will also have one or more cameras, a wireless communications module, a GPS tracking module, one or more proximity sensors for detecting the proximity of the transceivers 102, 103, 104, and a device interface and display (usually in the form of a touchscreen interface, but could also be a screen with separate buttons) configured to receive a distress input, alarm input, one or more trigger instructions, and one or more mode of operation instructions. The device also comprises a microphone and voice activation algorithms, and has a satellite communications module for emergency situations where there is no normal network service.

Each assisted response device 101 is controlled by a microprocessor or chip that outputs a distress signal to other assisted response devices within a predetermined radius or geographical location of the device and to one or more third parties such as through a direct line with law enforcement, and begin a recording with the one or more cameras when a distress input is received.

The microprocessor may also output an alarm signal in response to predetermined trigger instructions entered by a user or based on a selected mode of operation as described above in the summary section—the device can be changed between the various modes of operation to perform different functions such as vehicle tracking, setting alarms on transceivers, monitoring the heart rate of a user, etc.

In the present example the assisted response device 101 are in the form of a wearable device configured with one or more straps to be fastened about the forearm of a user.

The anti-theft transceiver tags (various types provided for different situations, including spike types 102, rig types 103, and ocu-receiver types 104) each couple to the assisted response devices so that when attached to objects owned by a user they alert the proximity sensors of the assisted response device when moved out of a certain range or away from a certain location if alarmed.

The assisted response device 101 can also couple directly with vehicles and other user devices 110 that have the appropriate software installed, so a tag is not always needed.

The assisted response device has integrated anti-theft technology itself and can set an alarm on itself as well as the transceivers. All alarms can be set to be silent through the interface.

Assets that can be alarmed, and that can have transceivers installed on them include but are not limited to: TVs, Desktop Computers, Laptop Computers, Notebook Computers, Cell Phones, iPads, Motor Vehicles, Bicycles, Motorcycles and Trikes, Storefronts, Homes, Storage Sheds, Apartments, Mobile Homes and RV's, Businesses, Stereo Equipment, Cameras, Guns Stocks, Movie Cameras and other photo equipment, Hospital Equipment, Boats, Planes, Helicopters, Gaming Systems, Watercrafts and Amphibious Vehicles, Purses, Handbags, Suitcases and other portable storage, Pieces of art, Priceless museum artifacts, Archaeology, Memorabilia, Pets, Protected Wildlife, other fauna that need active protection, High-End Construction Vehicles, Equipment and Tools, Shipping Containers, Lockers, Priceless Sporting Equipment, Golf Carts, Jewellery, Any AC/DC Device as well as any device not using AC/DC connections.

Exemplary user devices 110 as may be used in combination with the Personal safety and security system 100 by having the appropriate software installed thereon include, without limitation, a personal computer (PC) 111, a laptop 112, a tablet computer 113, and smartphone 114.

Generally, each user device 110 includes a display 115 and/or one or more processors. Each of the display 115 offers the user a visual interface for interaction with the personal safety and security system 100. For example, the personal safety and security system 100 may be presented as a browser interface that makes use of known techniques for user interaction.

Generally, each user device 110 is in communication with network 120 through communications channel 130. The network 120 is also in communication with server 140 and may further communicate with a database 150.

In this example, the server 140 contains instruction sets governing system operations and serves a plurality of user devices 110 having associated user accounts on the security system, forming an safety and tracking network. The database 150 may contain user account information, history, and personal data of the various users.

The foregoing are merely illustrative of the architecture of the Personal safety and security system 100 and is not meant to be limiting.

In this example, any user device 110 may include conventional software such as productivity tools (e.g., word processing, spreadsheets, etc.) and at least one browser. Tablet computer 113 or smartphone 114 may also include at least one “app” (defined generally as a purpose-oriented application that may include network communications as part of the functionality), as well as a biometric sensor 116 that can be a conventional optical scanner configured with an appropriate app for use as a fingerprint reader. The fingerprint reader may include software for receiving data from the scanner and interpreting the data within the context of a fingerprint. Other user devices 110 may include a biometric sensor 116 and/or other equipment useful for implementing authentication schemes.

In some examples, the system is also in communication with an emergency response system installed in one or more buildings (for example high rise buildings and sky scrapers where the risk of fire emergencies is high), the emergency response system in each building comprising a set of cameras, tracking sensors, and visual indicators, which in combination provide situational data on the whereabouts and status of building occupants during an emergency by broadcasting the video and tracking data over the network.

The cameras that will be used by first responders to monitor rooms and key populated areas of the building to further facilitate rescue and provide more confidence in their search, providing visual data on the subjects in the building and their health and whereabouts on top of the tracing technology of the assisted response device unit itself.

The cameras can also be used to coordinate a more organized rescue effort through the fire chief as the can have continuous sight of what is happening in his firemen's operation. This provides the ability to guide firefighters and first responders to the locations of trapped and distressed individuals in times of panic and confusion.

Visual indicators may also be provided being configured to guide responders to distressed building occupants and guide building occupants out of the building to aid in guiding the distressed to safety with the use of indicators of the safest path out of the building.

Assisted response devices 101 of those involved in responding to building emergencies may also have the guide and visual data overlaid on the display of their device. For example, assisted response device unit wearers may be provided with the conditions in each different room of the building and give one of two routes: for first responders it will provide the safest path to the distressed, and in the case of the distressed it will provide safest path to an exit. The first responders can also use readily available software from tablets and other devices 110, with the correct credentials, to access the network and monitor their fellow responders in the efforts.

The same system can also be used by policeman in happenings such as hostage situations or robberies, providing them a live feed of what is happening.

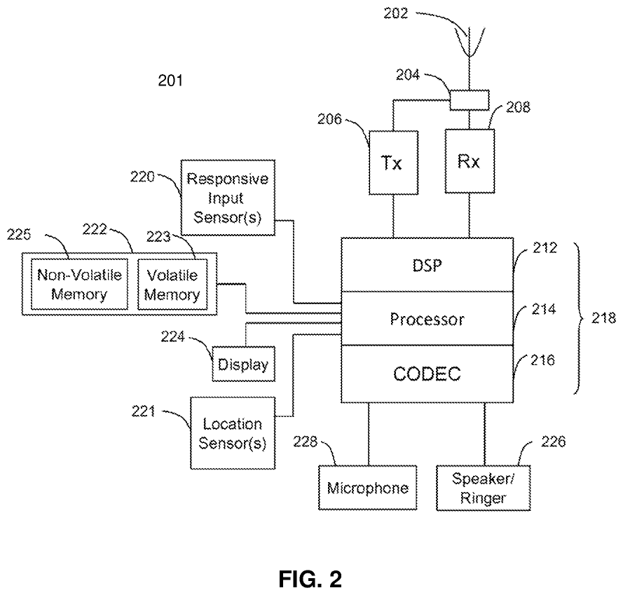

Referring to FIG. 2, there is shown the electrical components for an illustrative assisted response device 201 configuration.

For purposes of this patent, the illustrative wireless device 201 is a multimode wireless device that comprises a first antenna element 202 that is operatively coupled to a duplexer 204, which is operatively coupled to a multimode transmitter module 206, and a multimode receiver module 208.

The device 201 will have two forms of power. It will run on both replaceable batteries and internal rechargeable batteries. The two sources will make it much harder to run out of power when needed most and also make it harder to disable. It will be designed to run on DC power if necessary but will also be provided with a converter for ease in charging.

An illustrative control module 218 comprises a digital signal processor (DSP) 212, a processor 214, and a CODEC 216 that are communicatively coupled to the transmitter 206 and receiver 208. It shall be appreciated by those of ordinary skill in the art that the transmitter module and receiver module are typically paired and may be embodied as a transceiver. The illustrative transmitter 206, receiver 208, or transceiver is communicatively coupled to antenna element 202.

The DSP 812 may be configured to perform a variety of operations such as controlling the antenna 202, the multimode transmitter module 206, and the multimode receiver module 208. The processor 214 is operatively coupled to a responsive input sensor 220 such as a keypad or a touch screen.

The processor 214 is also operatively coupled to a memory 222, a display 224, and a sensor 221. The sensor 221 may be used to determine an indoor and outside location for the illustrative wireless device.

Additionally, the processor 212 is also operatively coupled to the CODEC module 216 that performs the encoding and decoding operations and is communicatively coupled to a speaker 226, and a microphone 228. The CODEC module 216 is also communicatively coupled to the display 224 and provides the encoding and decoding operations for video.

The memory 222 includes two different types of memory, namely, volatile memory 223 and non-volatile memory 225. The volatile memory 223 is computer memory that requires power to maintain the stored information, such as random access memory (RAM). The non-volatile memory 225 can retain stored information even when the wireless communication device 201 is not powered up. Some illustrative examples of non-volatile memory 225 include flash memory, ROM memory, and hard drive memory.

Wireless device 201 may be a mobile handset, mobile phone, wireless phone, portable cell phone, cellular phone, portable phone, a personal digital assistant (PDA), a tablet, a portable media device, a wearable computer, or any type of mobile terminal which is regularly carried by an end user and has all the elements necessary for operation in a wireless communication system. The wireless communications include, by way of example and not of limitation, CDMA, WCDMA, GSM, UMTS, or any other wireless communication system such as wireless local area network (WLAN), Wi-Fi or WiMAX.

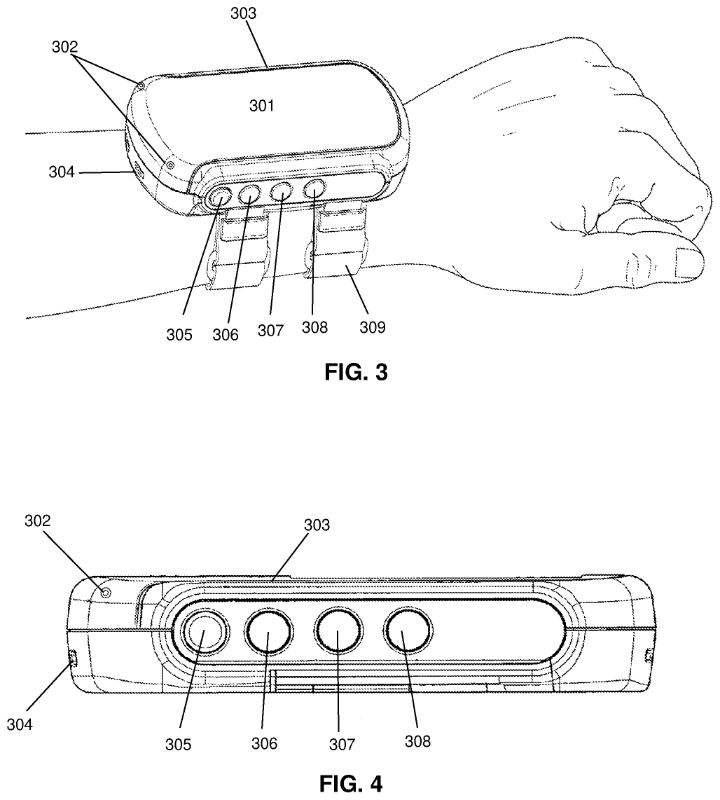

Referring to FIG. 3, an isometric perspective view of an example configuration of an assisted response device in accordance with the present disclosure is shown. FIG. 4 shows the same example configuration from the side.

The example illustration is designed for clarity, and is not representative of the actual dimensions the device will take.

As can be seen, the device is in the form of a gauntlet worn over the forearm, with the electrical components encased in a polymer housing. A large touchscreen interface 301 is provided on the top surface through which various controls and operations as described above can be implemented/accessed.

Dual wide-lens cameras 302 for recording the user's environment are provided on the exterior of the housing 303, which also comprises a charging port 304 for recharging the integrated internal batteries (separate from the replaceable battery compartment underneath that acts as back up power, there is also a back up transceiver).

In addition to the touchscreen interface 101, manual buttons are provided for accessing key features of the device. A distress button 305 is provided at the far left which will send an alarm out over the network. A mode of operation button 3067 switches through the different modes, and a select 307 and back 308 button are also provided for navigating the various menus and options.

Straps with fasteners 309 are provided for securing the device to the forearm, though clasps and other fastening mechanisms may be used instead.

It should be understood that the operations described herein may be carried out by any processor. In particular, the operations may be carried out by, but are not limited to, one or more computing environments used to implement the method such as a data center, a cloud computing environment, a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “activating”, “accessing”, “adding”, “applying”, “analyzing”, “associating”, “calculating”, “capturing”, “classifying”, “comparing”, “creating”, “defining”, “detecting”, “determining”, “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the safety and tracking system have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A personal safety and tracking system, the system comprising one or more assisted response devices in communication over a network, each assisted response device comprising:
two or more separate power sources;
one or more cameras;
a wireless communications module;
a GPS tracking module;
one or more proximity sensors;
a device interface and display configured to receive a distress input, alarm input, one or more trigger instructions, and one or more mode of operation instructions;
a controlling processor, the processor configured to output a distress signal to other assisted response devices within a predetermined radius or geographical location of the device and to one or more third parties, and to begin a recording with the one or more cameras, when a distress input is received; the processor being further configured to output an alarm signal in response to predetermined trigger instructions entered by a user or based on a selected mode of operation.

2. A personal safety and tracking system according to claim 1, wherein the assisted response devices are in the form of a wearable device configured with one or more straps to be fastened about the forearm of a user.

3. A personal safety and tracking system according to claim 1, wherein one of the power sources of each assisted response device is configured to receive a DC input, and is also provided with a DC/AC converter.

4. A personal safety and tracking system according to claim 1, wherein the device interface comprises a touchscreen interface.

5. A personal safety and tracking system according to claim 1, wherein the device interface comprises a manual distress button.

6. A personal safety and tracking system according to claim 1, wherein the device interface comprises a microphone coupled to a voice activation software of the controlling processor.

7. A personal safety and tracking system according to claim 1, wherein the separate power sources comprise a set of replaceable batteries and a set of internal rechargeable batteries.

8. A personal safety and tracking system according to claim 1, wherein the system further comprises a plurality of anti-theft transceiver tags coupled to the assisted response devices, the transceiver tags configured to be attached to one or more objects owned by a user and to communicate with the proximity sensors of the assisted response devices to alert a user when the object is moved a predetermined distance away from the assisted response unit.

9. A personal safety and tracking system according to claim 1, wherein the modes of operation include a network mode, and when in the network mode the device is configured to communicate over the network to check for other assisted response devices within a predetermined geographical area or radius.

10. A personal safety and tracking system according to claim 8, wherein the modes of operation include a proximity mode, and when in the proximity mode the device is configured to emit an alarm when a transceiver tag is moved further than a set limit away from the device.

11. A personal safety and tracking system according to claim 8, wherein the modes of operation include an alarm mode, and when in the alarm mode the device is configured to instruct a specific transceiver to set an alarm for a pre-determined amount of time, the alarm being triggered if the transceiver is moved without de-activating the alarm.

12. A personal safety and tracking system according to claim 8, wherein the system further comprises transceiver tags or tracking and alarm software specifically for vehicles, and wherein the vehicle tags or software are configured to generate an alert on the network when the vehicle is taken without the alarm being disabled, the alert containing information about the vehicle entered by a user, such as the number plate and a vehicle description, as well as continuously broadcasting the location of the vehicle.

13. A personal safety and tracking system according to claim 1, wherein each assisted response unit further comprises a satellite communications module, and wherein the modes of operation include a travel mode, and when in the travel mode the device is configured to communicate with the network, send alerts, and broadcast a user's location via the satellite communications module.

14. A personal safety and tracking system according to claim 1, wherein the assisted response device comprises an integrated heart rate sensor, and is configured to determine that a user is in distress under certain heartrate increase thresholds, and in response to broadcast a distress signal over the network.

15. A personal safety and tracking system according to claim 1, wherein the assisted response device comprises a first camera for taking photographs and a second camera for taking video recordings, and wherein the controlling processor is configured to broadcast photographs and video recordings taken over the network in combination with alarm or distress signals.

16. A personal safety and tracking system according to claim 1, wherein the assisted response device comprises voice recognition and recording software coupled to the microphone, and is configured to broadcast voice recordings taken over the network in combination with alarm or distress signals.

17. A personal safety and tracking system according to claim 1, wherein the system is in communication with an emergency response system installed in one or more buildings, the emergency response system in each building comprising a set of cameras, tracking sensors, and visual indicators, which in combination provide situational data on the whereabouts and status of building occupants during an emergency by broadcasting the video and tracking data over the network, and with the visual indicators being configured to guide responders to distressed building occupants and guide building occupants out of the building.

18. A personal safety and tracking system according to claim 17, wherein assisted response devices involved in responding to building emergencies have the guide and visual data overlaid on the display of their device.
